(19) United States
(12) Patent Application Publication
(10) Pub. No.: US 2011/0017327 A1
(43) Pub. Date: Jan. 27, 2011

(54) CARTRIDGE FOR A SANITARY FITTING

(76) Inventor: Frank Christ, Bausendorf (DE)

Correspondence Address: FULBRIGHT & JAWORSKI, LLP, 666 FIFTH AVE, NEW YORK, NY, 10103-3198, US

(21) Appl. No.: 12/863,266

(22) PCT Filed: Jan. 19, 2009
(86) PCT No.: PCT/EP09/50548

§ 371 Date: Oct. 13, 2010

(30) Foreign Application Priority Data
Jan. 21, 2008 (DE) 10 2008 000 108.2

(51) Int. Cl. A23G 9/28

(52) U.S. Cl. 137/602

(57) ABSTRACT

A cartridge for a sanitary fitting wherein the most highly used plate is moved and subjected to bending and torsion, and wherein the adjuster lever which for operation cooperates with the control opening for mixing the hot and cold water and which is moved by the housing has a cylindrical pivot bearing, by means of which the adjuster elevator is mounted in the bush to rotate about a non-mechanical pivot axis.

The invention relates to a cartridge for a sanitary fitting, wherein the housing of the cartridge, which is closed by a base plate, encloses: a valve-seat disc with inlet openings for cold and hot water and a discharge opening which runs into the outflow of the sanitary fitting, a control disc which is arranged so that it is displaceable with respect to the valve-seat disc and contains a mixing chamber that connects the inlet openings and the discharge opening of the valve-seat disc and in which the hot water is mixed with the cold water, and also a cover disc which is connected to the control disc on the side thereof that is remote from the valve-seat disc and is operatively connected to a control lever for displacing the discs, wherein the control lever is mounted in a bushing and is moved with the actuating lever of the fitting.

High demands are made on a cartridge for a sanitary fitting. It has to remain sealed over a long period of time. It is to be easy to actuate and in the same valve position is, as far as possible, always to deliver water at the same temperature. It is to be able to be produced efficiently and inexpensively, and the number of parts that are subject to wear is to be as low as possible.

The component of a cartridge that is strained the most is the control lever with which the control disc is moved. In the case of vertical actuation of the actuating lever that is connected to the control lever, the inflows are opened or closed; in the case of swivelling in the horizontal direction the hot-water flow and the cold-water flow are mixed together. As a result, the control lever is subjected to bending and torsional strain. As a rule, the control levers for the vertical swivelling movement are mounted on a mechanical axle which is mounted in a bushing which in turn is capable of being swivelled about a perpendicular axis in a horizontal plane. The bushing is mounted in the cartridge housing, as is known, for example, from DE 2356211 C2. Instead of being able to be swivelled about an axis, the control levers can also be swivel-mounted by means of a sphere, as is known, for example, from DE-OS 2923074. The sphere is mounted in a fixed bushing, and the control lever can be moved as desired in all directions on account of the mounting with a sphere.

Of these known mountings the mounting by means of a sphere is the most expensive, because in order to enclose the sphere the bushing which mounts it must be split and the production of a sphere requires precise processing. When mounting by means of an axle, the latter is subjected to bending strain, in particular when there is excessive expenditure of force during actuation. Moreover, corrosive deposits can impair the bearings of the axle.

It is therefore the object of the invention to put forward a structurally simple mounting of a control lever with as few components that are susceptible to wear as possible.

The object is achieved with the aid of the characterising features of the first claim. Further advantageous developments of the invention are claimed in the dependent claims.

The control lever is in one piece, and the mounting is effected without a mechanical swivel axle in a bushing in the housing. The control lever is composed of a lever arm, to which in turn the actuating lever of the fitting is secured, a cylindrical swivel bearing, and the carrier peg that is pre-formed thereon and reaches into a groove of the cover disc in order to actuate the control disc that is connected to it.

The control lever is formed in such a way that it can easily be pushed with the lever arm for the actuating lever in front into the bushing enclosing it and there in a recess of the bushing that is adapted to the cylinder shape of the swivel bearing is mounted without a mechanical swivel axle. The assembly of the control lever and the bushing is effected in a single working step by pushing the control lever into the bushing.

The cylindrical swivel bearing can be divided into two discs. Extending on both sides of the carrier peg for the actuation of the control disc between the two discs there is a groove into which respective cross-pieces of the bushing engage. The swivelling movement of the control lever can be adjusted by means of these cross-pieces in such a way that in the two end positions the maximum opening and optimum sealing of the respective openings are achieved by means of the control disc in the cartridge. In the case of the horizontal swivelling movement of the control lever for mixing the hot- and cold-water flow the bushing is entrained by means of the cross-pieces in the grooves. As a result of the application to the cross-pieces of the force that is required for the horizontal swivelling movement the cylindrical swivel bearing that is provided for the vertical swivelling movement is not loaded by the force for the horizontal swivelling movement.

Cartridges should be designed for at least 100000 actuations without signs of wear, in particular leakages. In the case of high-quality fittings a design for 500000 actuations is striven for. The control lever is here the component that is under the most strain, in particular bending strain, on account of its mounting. For this reason the choice of materials for the control lever and the bushing as the bearing is particularly important. The control lever is advantageously an injection-moulded part of polyamide which can be additionally reinforced by high-strength fibres, for example glass fibres. Polyoxymethylene (POM) is to be recommended for the bushing as the sliding partner and bearing for the control lever. A pairing of materials of POM and Teflon in a bearing is also conceivable.

In order to reduce the friction between the control lever and the bushing as the bearing, there is provision for lubrication with suitable grease, advantageously synthetic grease, for example a silicone grease with Teflon particles. The grease is stored in grease chambers that are provided on the bearing faces where contact faces of the control lever and the bushing moving against each other are located. The grease chambers are as a rule only provided on one of the bearing faces, either on the bearing faces of the bushing or on the bearing faces of the control lever. The grease chambers consist of small depressions which are arranged on the bearing face and in which the grease is stored. A depression for the grease chambers is to be provided on a face such that a uniform supply of the lubricant is guaranteed. The size, the shape and the number of grease chambers are determined by the size of the bearing face, its length and its width. The grease chambers can be from 1 mm to a few tenths of a millimetre deep and with an adapted cross section have widths and lengths of respectively approximately 1 mm to 3 mm. Grease chambers with a circular cross section with diameters up to 3 mm are also possible.

The bushing with the control lever mounted in it can be stayed with a conically shaped face on a likewise conically shaped face of the front wall of the cylindrically shaped housing. This face serves as a bearing face of the bushing when actuating the control disc for mixing the hot- and cold-water flow. Thus the otherwise horizontal and, if applicable, additional vertical bearing face in the housing front wall can be dispensed with. In particular, two bearing faces lead to increased frictional resistance. With the simultaneous swivelling and tilting movements of the control lever, the introduction of force into the housing is substantially more favourable than in the case of a conventional mounting of the bushing. In order to reduce the friction between the bushing and the housing, grease chambers can also be provided on these bearing faces.

The invention is explained in greater detail with reference to an exemplary embodiment. In the drawing:

FIG. 1 shows a plan view of the cartridge in the symmetrical closed position with sectional courses drawn in;

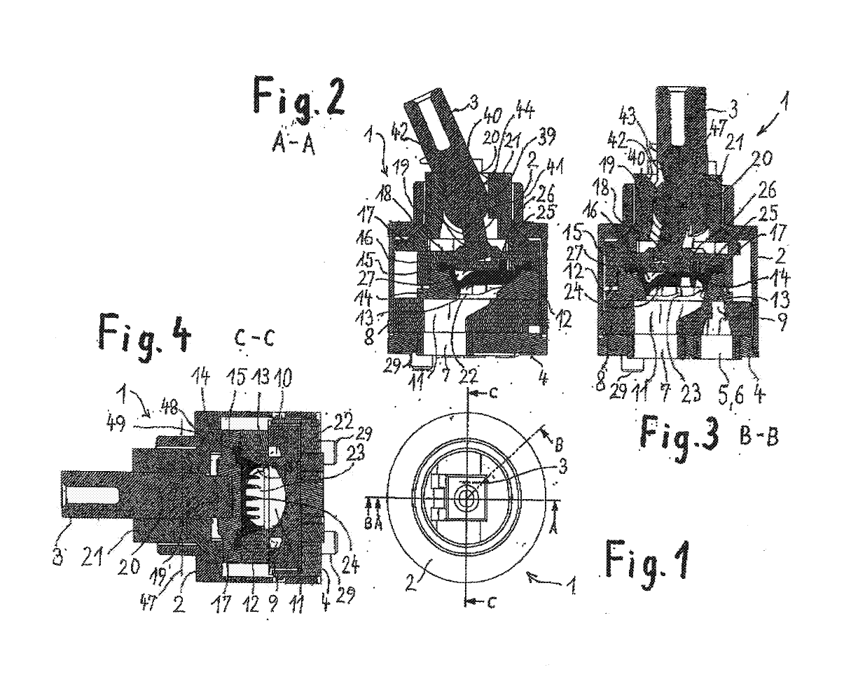

FIG. 2 shows a view of the cartridge in accordance with the sectional course A-A in the symmetrical mixing position, open;

FIG. 3 shows a view of the cartridge in accordance with the sectional course B-B in the symmetrical closed position;

FIG. 4 shows a view of the cartridge in accordance with the sectional course C-C in the symmetrical closed position;

FIG. 5 shows a view of the control lever looking at its rear side;

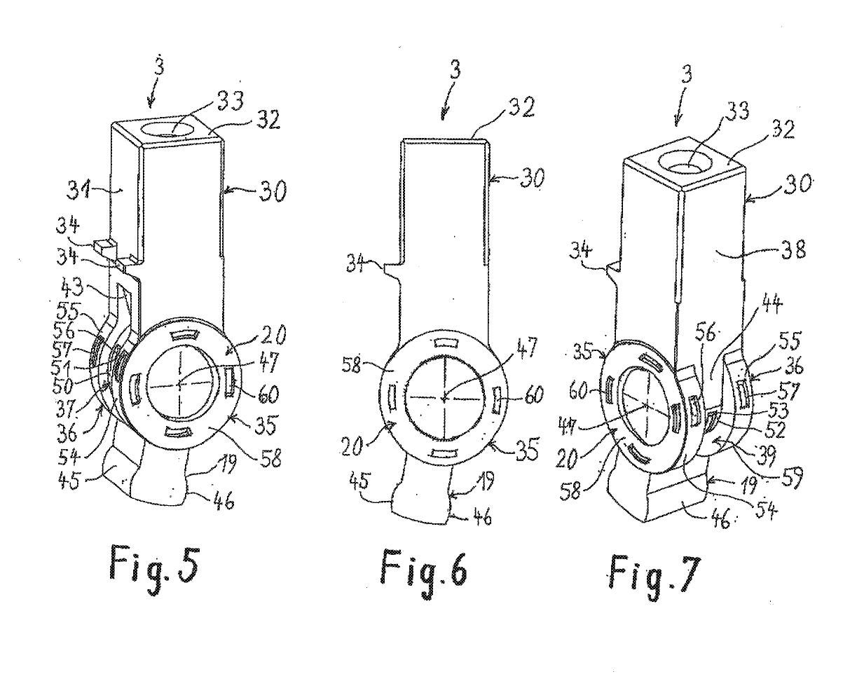

FIG. 6 shows a side view of the control lever; and

FIG. 7 shows a view of the control lever looking at its front side.

A plan view of the cartridge 1 in the closed position is shown in FIG. 1. Laid over the housing 2, from which the control lever 3 projects for actuation of the control disc, are the sectional lines under which the sections that are presented in the following figures run through the cartridge.

A view of the section through the cartridge 1 is shown in accordance with the course A-A in a symmetrical mixing position, open, in FIG. 2 and in accordance with the courses B-B and C-C in the closed position in FIGS. 3 and 4.

The housing 2 is closed off on the underside by a base plate 4 with the connection openings 5 and 6 for the cold and hot water respectively and the connection opening 7 for the mixed water flowing off. Lying above this there is the valve-seat disc 8 of which the inlet openings 9 and 10 and the discharge opening 11 correspond with the openings 5 and 6 respectively and 7 of the base plate 4.

The section A-A runs centrally through the discharge opening 11. The section B-B runs centrally through the inlet opening 10 and bends off at the central point of the control lever 3 in order from there to run centrally through the discharge opening 11. The section C-C runs perpendicularly to the sectional course A-A, through the central point of the control lever 3 in the closed position.

The control disc 12 lies above the valve-seat disc 8 in a displaceable manner. In FIG. 2 it is in the open position; in FIGS. 3 and 4 it is in the closed position. It closes the inlet openings 9 and 10. The control disc 12 centrally has a circular break-through 13 into which a body 14 is inserted in order to prevent or damp the flow noises. In the present exemplary embodiment the body consists of an elastomer. The cover disc 15 lies above this. In order to seal the break-through 13, the body 14 overlaps the control disc 12 with an annular bead 16 as a sealing element that is mounted in a correspondingly shaped groove 17 of the cover disc 15.

The carrier peg 19 of the control lever 3 engages into a groove or depression 18 of the carrier or cover disc 15. The control lever 3 is mounted with a cylindrical swivel bearing 20, whose swivel axis 47 is perpendicular to the longitudinal axis of the control lever 3, without a mechanical swivel axle, in a bushing 21 that is enclosed by the housing 2.

The body 14 to prevent or damp the flow noises forms a hollow-spherical arch 22, a hollow sphere, of the mixing chamber 23 with respect to the valve-seat disc 8. As can be seen from the figures, in particular from FIG. 4, ribs 24 extending in parallel are arranged in this hollow sphere 22.

Here the distance between the outer ribs is smaller than the distance between the inner ribs. The body 14 bears on its side that is remote from the hollow sphere 22 a cross-piece or peg 25 which for centring purposes reaches into a correspondingly shaped groove or depression 26 of the cover disc 15.

In the present exemplary embodiment a hollow space 27 that contains an air cushion can be seen above the hollow sphere 22 of the body 14, between the cover disc 15 and the body 14, here in the region of the discharge opening 11. As a result of the elasticity of the body 14, when pressure fluctuations occur it is possible for the body 14 to deflect into this space 27 and damp the pressure surges that occur.

The pegs 29 are used for centring and securement in the fitting.

In the present exemplary embodiment the bushing 21 is stayed with the control lever 3 that is mounted in it on a conically shaped portion of the front wall 48 of the cylindrically shaped housing 2 with a likewise conically shaped face 49 at an angle of 40 degrees (for reference numerals see FIG. 4). This face is the bearing face of the bushing 21 when the control disc 12 is actuated for mixing the hot- and cold-water flow. In order to reduce friction, grease chambers can be provided on one of these bearing faces.

FIGS. 5 to 7 show respective views of the control lever 3. The control lever is composed of the lever arm 30, to which the actuating lever of the fitting is secured, the cylindrical swivel bearing 20, and the carrier peg 19 that is pre-formed thereon.

The rear side 31 of the control lever 3, the side of the control lever 3 that is remote from the actuator of the fitting, can be seen in FIG. 5. It is the side that rests against the bushing 21 when the inlet openings 9 and/or 10 are completely open. The lever arm 30 has on its upper side 32 a threaded opening 33 for securement of the actuating lever of the fitting that is stayed on the extensions 34 and is centred by them.

The swivel bearing 20 is cylindrical and is composed of two discs 35 and 36 with the swivel axis 47 as the central point, the discs being separated from each other in each case on the rear side 31 of the control lever 3 by a groove 37 and on the front side 38, the side facing the actuator, likewise by a groove 39. The grooves are separated from each other by the carrier peg 19. The grooves 37 and 39 are used for centring and guidance in the bushing 21 which by means of a cross-piece 40 engages into the groove 37 and by means of a cross-piece 41 engages into the groove 39, as can be seen from the sectional views of FIGS. 2 and 3. This cross-piece/groove combination renders possible positionally correct assembly of the control lever 3 and bushing 21, guidance of the control lever 3 during the swivelling movement for opening and closing the inlet openings 9 and/or 10, and entrainment of the bushing 21 in the case of the horizontal swivelling movement of the control lever 3 for actuation of the control disc 12 for mixing the hot-water flow and cold-water flow.

In order to limit the swivelling movement of the control lever 3 for opening and closing the inlet openings 9 and/or 10 about the swivel axis 47, the bushing 21 has on the cross-piece 40 a stop face 42 on which in the position of maximum opening of the inlet openings 9 and/or 10 and also the discharge opening 11 the control lever 3 rests with the face 43 of the groove 37, as can be seen from FIG. 2. In the closed position, the control lever 3 rests with the face 44 of the front side 38 between the discs 35 and 36 in the front groove 39 against the cross-piece 41 of the bushing 21.

The cross-piece-shaped carrier peg 19 has respective convex side faces 45 and 46 with which in the case of the swivelling movement for opening and closing purposes it can roll about the swivel axis 47 in the groove or depression 18 of the cover disc 15.

In order to reduce the friction at the bearing faces of the control lever 3 and the bushing 21, at least one grease chamber is provided either on the bearing faces of the bushing or, as shown here, on the bearing faces of the control lever 3. At least one grease chamber 51 is provided on the bearing face 50 in the groove 37 at the rear. Likewise at least one grease chamber 53 is provided on the bearing face 52 in the groove 39 at the front. Furthermore, at least one grease chamber 56 and 57 is provided on the bearing faces 54 and 55 of the discs 35 and 36 respectively of the swivel bearing 20.

Grease chambers 60 can likewise be provided on the front side 58 of the disc 35 and also on the front side 59 of the disc 36 of the swivel bearing 20, distributed at equal distances over the periphery, if the front sides 58 and 59, as in this exemplary embodiment, rest flat against the bushing 21. The grease chambers in the present exemplary embodiment are 5/10 mm deep, 1 mm wide and 3 mm long.

1-14. (canceled)

15. A cartridge for a sanitary fitting, wherein the housing of the cartridge, which is closed by a base plate, encloses: a valve-seat disc with inlet openings for cold and hot water and a discharge opening which runs into the outflow of the sanitary fitting, a control disc which is arranged so that it is displaceable with respect to the valve-seat disc and contains a mixing chamber that connects the inlet openings and the discharge opening of the valve-seat disc and in which the hot water is mixed with the cold water, and also a cover disc which is connected to the control disc on the side thereof that is remote from the valve-seat disc and is operatively connected to a control lever for displacing the discs, the control lever being moved with the actuating lever of the fitting and being mounted in a bushing enclosed by the housing, wherein the control lever has a cylindrical swivel bearing with which it is swivel-mounted about a non-mechanical swivel axis in the bushing to open and close the inlet openings and also the discharge opening.

16. A cartridge according to claim 15, wherein the cylindrical swivel bearing consists of two discs and, wherein the non-mechanical swivel axis extends through the central point of the discs, in that the two discs and are separated from each other in each case on the rear side of the control lever by a rear groove and on the front side, the side facing the actuator, by a front groove, and in that a respective cross-piece and of the bushing engages into these grooves for guidance in the case of the vertical swivelling movement of the control lever.

17. A cartridge according to claim 16, wherein in the case of the horizontal swivelling movement of the control lever for opening and closing the inlet openings and also the discharge opening for mixing the hot- and the cold-water flow the bushing is operatively connected to the control lever by means of the cross-pieces and respectively between the two discs and of the cylindrical swivel bearing.

18. A cartridge according to claim 16, wherein the cross-pieces and respectively of the bushing between the two discs and of the swivel bearing are the stops for the control lever in the case of the swivelling movement for opening and closing the inlet openings and the discharge opening.

19. A cartridge according to claim 18, wherein the cross-piece of the bushing has a stop face for limiting the swivelling movement of the control lever by application against the face of the rear groove when opening the inlet openings and the discharge opening.

20. A cartridge according to claim 18, wherein in the closed position of the control lever the face of the front side rests against the cross-piece of the bushing in the front groove between the discs.

21. A cartridge according to claim 15, wherein the control lever has for the displacement and swivelling of the control disc a cross-piece-shaped carrier peg by which it is operatively connected to the control disc by way of the cover disc.

22. A cartridge according to claim 21, wherein the cross-piece-shaped carrier peg has in each case convex side faces.

23. A cartridge according to claim 15, wherein the control lever can be inserted into the bushing from the side where the cover disc is arranged, and in that the cross-pieces of the bushing constitute the guidance for the positionally correct insertion and the fixation of the control lever.

24. A cartridge according to claim 15, wherein the bearing faces in the grooves and the bearing faces on the discs of the control lever mounted in the bushing that are arranged concentrically to the swivel axis have grease chambers.

25. A cartridge according to claim 15, wherein the control lever has grease chambers on its bearing faces perpendicularly to the swivel axis, on the discs of the swivel bearing.

26. A cartridge according to claim 25, wherein the grease chambers are arranged concentrically about the swivel axis.

27. A cartridge according to claim 15, wherein the bushing that is mounted in the housing has grease chambers on its bearing face.

28. A cartridge according to claim 15, wherein the housing, in which the bushing is mounted with the control lever mounted in it, has grease chambers on its bearing face.
